(19) United States
(12) Patent Application Publication
(10) Pub. No.: US 2019/0159215 A1
(43) Pub. Date: May 23, 2019

(54) Multi-TRP Interference Control in Wireless Communications

(71) Applicant: MediaTek Inc., Hsinchu City (TW)

(72) Inventors: Chao-Cheng Su, Hsinchu City (TW); Weidong Yang, San Diego, CA (US); Tzu-Han Chou, San Jose, CA (US); Lung-Sheng Tsai, Hsinchu City (TW)

(21) Appl. No.: 16/190,148

(22) Filed: Nov. 14, 2018

Related U.S. Application Data
(60) Provisional application No. 62/588,206, filed on Nov. 17, 2017.

(51) Int. Cl. H04W 72/08; H04L 5/00

(52) U.S. Cl. CPC H04W 72/082; H04L 5/0073; H04L 5/0051

(57) ABSTRACT

Various examples pertaining to multi-transmit/receive point (TRP) interference control in wireless communications are described. A processor of a user equipment (UE) receives, from a network node, a downlink measurement reference signal and configures an interference measurement resource (IMR) associated with a sounding reference signal (SRS) resource of the UE based on the DL measurement reference signal. The processor measures a channel response of a communication channel between the UE and the network node. The processor also measures an interference using the IMR. The processor then generates a precoder based on the measured channel response and the measured interference. The processor further performs an uplink transmission to the network node using the precoder.

### CROSS REFERENCE TO RELATED PATENT APPLICATION(S)

The present disclosure is part of a non-provisional application claiming the priority benefit of U.S. Patent Application No. 62/588,206 filed on 17 Nov. 2017, the content of which is incorporated by reference in its entirety.

### TECHNICAL FIELD

The present disclosure is generally related to wireless communications and, more particularly, to multi-transmit/receive point (TRP) interference control in wireless communications.

### BACKGROUND

Unless otherwise indicated herein, approaches described in this section are not prior art to the claims listed below and are not admitted as prior art by inclusion in this section.

According to current the 3rd-Generation Partnership Project (3GPP) specification for the 5th-Generation (5G)/New Radio (NR) mobile communications, for non-codebook based uplink (UL) transmissions, a non-zero power (NZP) channel state information (CSI) reference signal (CSI-RS) associated with a sounding reference signal (SRS) can be used by a user equipment (UE) to derive a downlink channel. Moreover, the UE can also derive the dominant eigenvector(s) for precoded UL transmission of the SRS. However, UL transmissions by the UE to a base station of a cell with which the UE is associated can cause interference on another base station of a neighboring cell.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of a user equipment (UE) performing various operations, including: (1) receiving from a network node of a wireless network a downlink (DL) measurement reference signal; (2) configuring an interference measurement resource (IMR) associated with a sounding reference signal (SRS) resource of the UE based on the DL measurement reference signal; (3) measuring a channel response of a communication channel between the UE and the network node; (4) measuring an interference using the IMR; (5) generating a precoder based on the measured channel response and the measured interference; and (6) performing an uplink (UL) transmission to the network node using the precoder.

In one aspect, a method may involve a processor of a UE performing various operations, including: (1) receiving from a first network node of a wireless network a DL measurement reference signal that configures the UE with an IMR associated with a SRS resource of the UE; (2) measuring an interference using the IMR; (3) generating a precoder based at least in part on the measured interference; and (4) performing an UL transmission to the first network node using the precoder such that an amount of interference caused by the UL transmission on a second network node of the wireless network is reduced.

In one aspect, an apparatus may include a processor. The processor may be capable of performing various operations, including: (1) receiving from a network node of a wireless network a DL measurement reference signal; (2) configuring a channel measurement resource (CMR) associated with a SRS resource of the apparatus based on the DL measurement reference signal; (3) configuring an IMR associated with the SRS resource based on the DL measurement reference signal; (4) measuring a channel response of a communication channel between the UE and the network node using the CMR; (5) measuring an interference using the IMR; (6) generating a precoder based on the measured channel response and the measured interference; and (7) performing an UL transmission to the network node using the precoder.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies wherever applicable such as, for example and without limitation, Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in which various schemes in accordance with the present disclosure may be implemented.

FIG. 2 is a diagram of an example apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not

be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multi-TRP interference control in wireless communications. According to the present disclosure, a number of possible schemes/solutions may be implemented separately or jointly. That is, although these possible solutions may be described below separately, two or more of these possible solutions may be implemented in one combination or another.

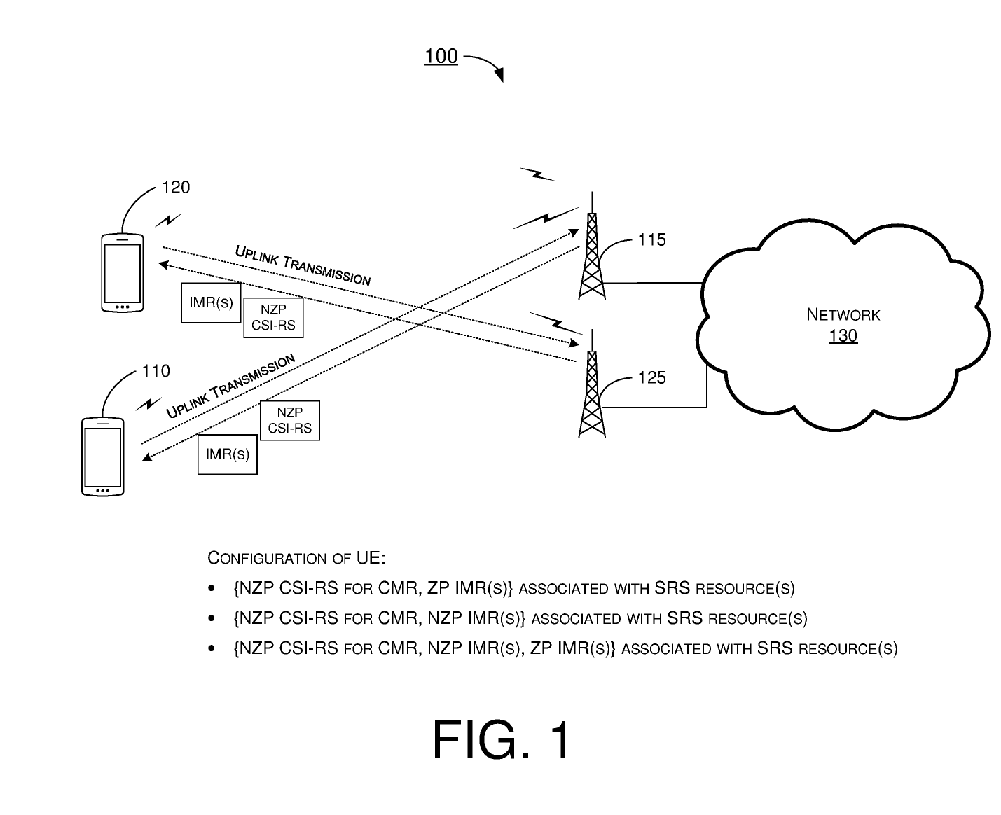

FIG. 1 illustrates an example scenario 100 in which various schemes in accordance with the present disclosure may be implemented. Scenario 100 may involve a first UE (shown as UE 110 in FIG. 1), a second UE (shown as UE 120 in FIG. 1), a first network node (shown as network node 115 in FIG. 1), a second network node (shown as network node 125 in FIG. 1) and a wireless network 130. In the context of 5G/NR, network 130 may be a 5G/NR mobile communication network, and each of network node 115 and network node 125 may be a TRP or gNB. In scenario 100, UE 110 may be in a first cell associated with network node 115, and UE 120 may be in a second cell associated with network node 125. That is, UE 110 may be engaged in wireless communications with network node 115, and UE 120 may be engaged in wireless communications with with network node 125. Network node 115 and network node 125 may be in the vicinity or neighborhood of each other. Consequently, network node 115 may be subject to interference by UL transmissions from UE 120, and network node 125 may be subject to interference by UL transmissions from UE 110.

According to the 3GPP specification, network node 115 may configure UE 110 by a DL measurement reference signal (e.g., a NZP CSI-RS) and, correspondingly, UE 110 may measure a channel response of a communication channel between UE 110 and network node 115. UE 110 may then perform an eigen-value decomposition (EVD) or singular-value decomposition (SVD) on the channel response to determine or otherwise identify a most significant eigen vector or singular vector to be used for UL transmissions to network node 115. Similarly, network node 125 may configure UE 120 by a DL measurement reference signal (e.g., a NZP CSI-RS) and, correspondingly, UE 120 may measure a channel response of a communication channel between UE 120 and network node 125. UE 120 may then perform an EVD or SVD on the channel response to determine or otherwise identify a most significant eigen vector or singular vector to be used for UL transmissions to network node 125. It is noteworthy that the assumption here is that DL channel condition and UL channel condition are the same or symmetrical and, hence, UL channel information can be deduced from DL channel information. Accordingly, in constructing a precoder for UL transmissions under a conventional approach, each of UE 110 and UE 120 is likely to generate the precoder so that a direction for UL transmissions is toward a direction from which DL signals are received. However, under the conventional approach, undesirable interference on a network node of a neighboring cell can result due to UL transmissions from a UE.

Under a proposed scheme in accordance with the present disclosure, in addition to measurement of channel response, each of UE 110 and UE 120 may be configured by network node 115 and network node 125, respectively, to measure interference(s). Accordingly, in constructing a precoder for UL transmissions, each of UE 110 and UE 120 may consider the measured channel response for a desired signal as well as the measured interference(s). For instance, based on the measured interference(s), each of UE 110 and UE 120 may perform pre-whitening in constructing the precoder so that a direction of UL transmissions may be skewed or otherwise directed more toward its respective network node (network node 115 or network node 125, respectively) with less signal strength in the direction of the neighboring network node.

Under the proposed scheme, network node 115 may utilize its DL measurement reference signal to configure a channel measurement resource (CMR) associated with one or more sounding reference signal (SRS) resources of UE 110, and network node 125 may utilize its DL measurement reference signal to configure a CMR associated with one or more SRS resources of UE 110. Additionally, network node 115 may utilize its DL measurement reference signal to configure one or more interference measurement resources (IMRs) associated with one or more SRS resources of UE 110, and network node 125 may utilize its DL measurement reference signal to configure one or more IMRs associated with one or more SRS resources of UE 120. In some cases, the one or more IMRs may include one or more zero-power (ZP) IMRs. In some cases, the one or more IMRs may include one or more NZP IMRs. In some cases, the one or more IMRs may include one or more NZP IMRs and one or more ZP IMRs. Thus, when constructing or otherwise generating a precoder for UL transmissions, each of UE 110 and UE 120 may generate the precoder based on the measured channel response and the measured interference(s).

### Illustrative Implementations

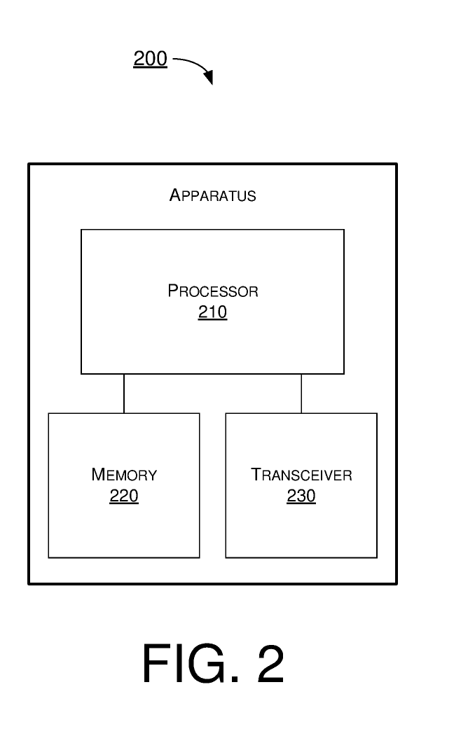

FIG. 2 illustrates an example apparatus 200 in accordance with an implementation of the present disclosure. Apparatus 200 may perform various functions to implement procedures, schemes, techniques, processes and methods described herein pertaining to multi-TRP interference control in wireless communications, including the various procedures, scenarios, schemes, solutions, concepts and techniques described above as well as processes 300 and 400 described below.

Apparatus 200 may be a part of an electronic apparatus, which may be a UE such as a portable or mobile apparatus, a wearable apparatus, a wireless communication apparatus or a computing apparatus. For instance, apparatus 200 may be implemented in a smartphone, a smartwatch, a personal digital assistant, a digital camera, or a computing equipment such as a tablet computer, a laptop computer or a notebook computer. Moreover, apparatus 200 may also be a part of a machine type apparatus, which may be an IoT or NB-IoT apparatus such as an immobile or a stationary apparatus, a home apparatus, a wire communication apparatus or a computing apparatus. For instance, apparatus 200 may be implemented in a smart thermostat, a smart fridge, a smart door lock, a wireless speaker or a home control center. Alternatively, apparatus 200 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Apparatus 200 may include at least some of those components shown in FIG. 2 such as a processor 210. Apparatus 200 may further include one or more other components not pertinent to the proposed scheme of the present disclosure (e.g., an internal power supply, display device and/or user interface device), and, thus, such component(s) of apparatus 200 are neither shown in FIG. 2 nor described below in the interest of simplicity and brevity.

In one aspect, processor 210 may be implemented in the form of one or more single-core processors, one or more multi-core processors, one or more RISC processors, or one or more CISC processors. That is, even though a singular term “a processor” is used herein to refer to processor 210, processor 210 may include multiple processors in some implementations and a single processor in other implementations in accordance with the present disclosure. In another aspect, processor 210 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 210 is a special-purpose machine specifically designed, arranged and configured to perform specific tasks pertaining to multi-TRP interference control in wireless communications in accordance with various implementations of the present disclosure.

In some implementations, apparatus 200 may also include a transceiver 230 coupled to processor 210 and capable of wirelessly transmitting and receiving data, signals and information. In some implementations, transceiver 230 may be equipped with a plurality of antenna ports (not shown) such as, for example, four antenna ports. In some implementations, apparatus 200 may further include a memory 220 coupled to processor 210 and capable of being accessed by processor 210 and storing data therein.

To aid better understanding, the following description of operations, functionalities and capabilities of apparatus 200 is provided in the context of scenario 100 in which apparatus 200 is implemented in or as UE 110 or UE 120. In the interest of brevity, description of the operations, functionalities and capabilities is provided below for apparatus 200 being implemented in or as UE 110, which is equally applicable to apparatus 200 being implemented in or as UE 120.

In one aspect, processor 210 of apparatus 200 may receive, via transceiver 230 from network node 115 of wireless network 130, a DL measurement reference signal. Processor 210 may configure an IMR associated with a SRS resource of apparatus 200 based on the DL measurement reference signal. Processor 210 may also configure a CMR associated with the SRS resource based on the DL measurement reference signal. Processor 210 may measure a channel response of a communication channel between apparatus 200 (as UE 110) and network node 115. Processor 210 may also measure an interference using the IMR. Processor 210 may generate a precoder based on the measured channel response and the measured interference. Processor 210 may perform an UL transmission to network node 115 using the precoder.

In another aspect, processor 210 may receive, via transceiver 230 from network node 115 of wireless network 130, a DL measurement reference signal. Processor 210 may configure an IMR associated with a SRS resource of apparatus 200 based on the DL measurement reference signal. Processor 210 may measure an interference using the IMR. Processor 210 may generate a precoder based at least in part on the measured interference. Processor 210 may perform an UL transmission to network node 115 using the precoder such that an amount of interference caused by the UL transmission on network node 125 of wireless network 130 is reduced.

In some implementations, the IMR may include one or more ZP IMRs. Alternatively, the IMR may include one or more NZP IMRs. Still alternatively, the IMR may include one or more ZP IMRs and one or more NZP IMRs.

In some implementations, in receiving the DL measurement reference signal, processor 210 may receive, via transceiver 230, an NZP CSI-RS.

In some implementations, processor 210 may perform an eigen-value decomposition (EVD) or singular-value decomposition (SVD) on the channel response to determine a vector for the UL transmission. Moreover, in generating the precoder based on the measured channel response and the measured interference, processor 210 may generate the precoder using the vector and based on the measured interference.

In some implementations, in performing the UL transmission to network node 115 using the precoder processor 210 may transmit, via transceiver 230, a SRS to network node 115 using the precoder.

### Illustrative Processes

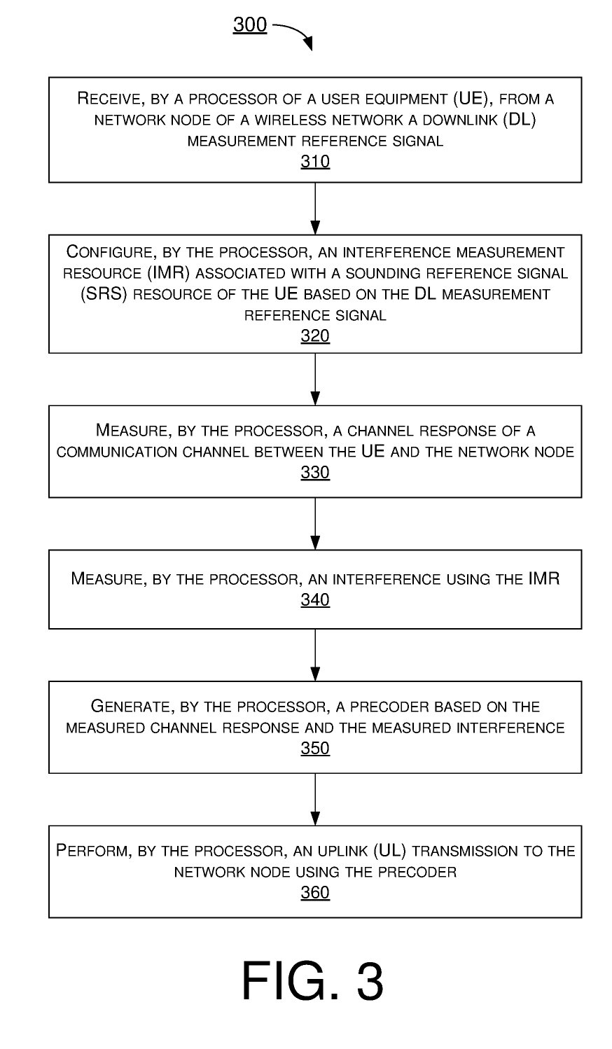

FIG. 3 illustrates an example process 300 in accordance with an implementation of the present disclosure. Process 300 may be an example implementation of the various procedures, scenarios, schemes, solutions, concepts and techniques, or a combination thereof, whether partially or completely, with respect to multi-TRP interference control in wireless communications in accordance with the present disclosure. Process 300 may represent an aspect of implementation of features of apparatus 200 and/or apparatus 220. Process 300 may include one or more operations, actions, or functions as illustrated by one or more of blocks 310, 320, 330, 340, 350 and 360. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Furthermore, one or more of the blocks of process 300 may be repeated one or more times. Process 300 may be implemented by apparatus 200 or any suitable UE or machine type devices. Solely for illustrative purposes and without limitation, process 300 is described below in the context of scenario 100 with apparatus 200 implemented as UE 110. Process 300 may begin at block 310.

At 310, process 300 may involve processor 210 of apparatus 200 receiving, via transceiver 230 from network node 115 of wireless network 130, a DL measurement reference signal. Process 300 may proceed from 310 to 320.

At 320, process 300 may involve processor 210 configuring an IMR associated with a SRS resource of apparatus 200 based on the DL measurement reference signal. Process 300 may proceed from 320 to 330.

At 330, process 300 may involve processor 210 measuring a channel response of a communication channel between apparatus 200 (as UE 110) and network node 115. Process 300 may proceed from 330 to 340.

At 340, process 300 may involve processor 210 measuring an interference using the IMR. Process 300 may proceed from 340 to 350.

At 350, process 300 may involve processor 210 generating a precoder based on the measured channel response and the measured interference. Process 300 may proceed from 350 to 360.

At 360, process 300 may involve processor 210 performing an UL transmission to network node 115 using the precoder.

In some implementations, the IMR may include one or more ZP IMRs. Alternatively, the IMR may include one or more NZP IMRs. Still alternatively, the IMR may include one or more ZP IMRs and one or more NZP IMRs.

In some implementations, in receiving the DL measurement reference signal, process 300 may involve processor 210 receiving, via transceiver 230, an NZP CSI-RS.

In some implementations, process 300 may further involve processor 210 performing other operations. For instance, process 300 may involve processor 210 configuring a CMR associated with the SRS resource of apparatus 200 based on the NZP CSI-RS. Moreover, process 300 may further involve processor 210 performing an eigen-value decomposition (EVD) or singular-value decomposition (SVD) on the channel response to determine a vector for the UL transmission.

In some implementations, in generating the precoder based on the measured channel response and the measured interference, process 300 may further involve processor 210 generating the precoder using the vector and based on the measured interference.

In some implementations, in performing the UL transmission to network node 115 using the precoder, process 300 may involve processor 210 transmitting, via transceiver 230, a SRS to network node 115 using the precoder.

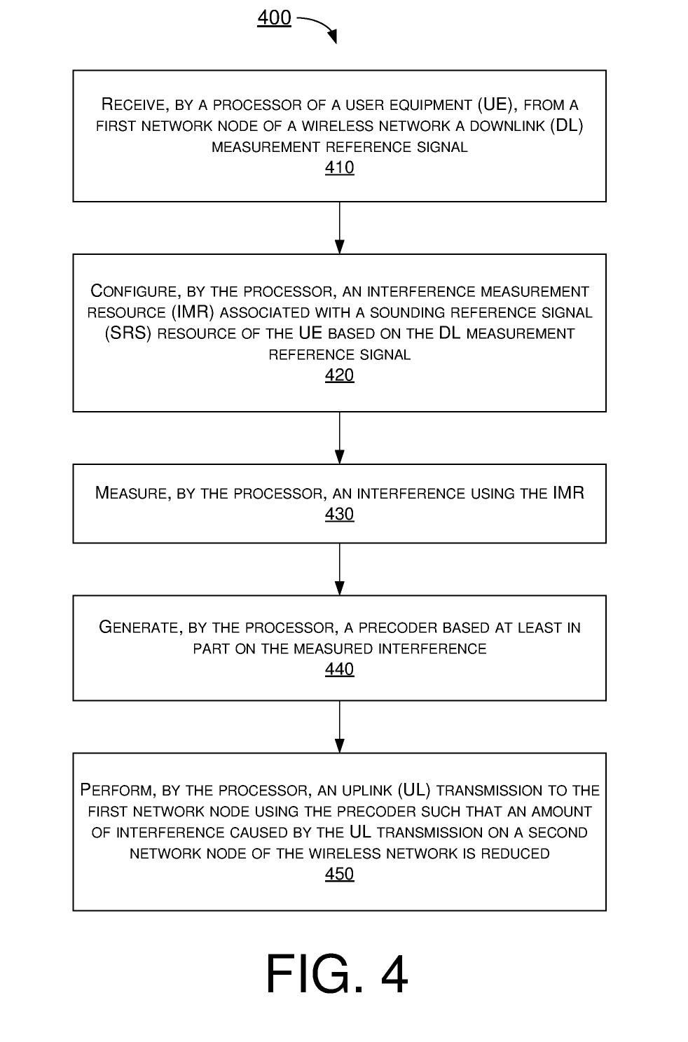

FIG. 4 illustrates an example process 400 in accordance with an implementation of the present disclosure. Process 400 may be an example implementation of the various procedures, scenarios, schemes, solutions, concepts and techniques, or a combination thereof, whether partially or completely, with respect to multi-TRP interference control in wireless communications in accordance with the present disclosure. Process 400 may represent an aspect of implementation of features of apparatus 200 and/or apparatus 220. Process 400 may include one or more operations, actions, or functions as illustrated by one or more of blocks 410, 420, 430, 440 and 450. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Furthermore, one or more of the blocks of process 400 may be repeated one

or more times. Process 400 may be implemented by apparatus 200 or any suitable UE or machine type devices. Solely for illustrative purposes and without limitation, process 400 is described below in the context of scenario 100 with apparatus 200 implemented as UE 110. Process 400 may begin at block 410.

At 410, process 400 may involve processor 210 of apparatus 200 receiving, via transceiver 230 from network node 115 of wireless network 130, a DL measurement reference signal. Process 400 may proceed from 410 to 420.

At 420, process 400 may involve processor 210 configuring an IMR associated with a SRS resource of apparatus 200 based on the DL measurement reference signal. Process 400 may proceed from 420 to 430.

At 430, process 400 may involve processor 210 measuring an interference using the IMR. Process 400 may proceed from 430 to 440.

At 440, process 400 may involve processor 210 generating a precoder based at least in part on the measured interference. Process 400 may proceed from 440 to 450.

At 450, process 400 may involve processor 210 performing an UL transmission to network node 115 using the precoder such that an amount of interference caused by the UL transmission on network node 125 of wireless network 130 is reduced.

In some implementations, the IMR may include one or more ZP IMRs. Alternatively, the IMR may include one or more NZP IMRs. Still alternatively, the IMR may include one or more ZP IMRs and one or more NZP IMRs.

In some implementations, in receiving the DL measurement reference signal, process 300 may involve processor 210 receiving, via transceiver 230, an NZP CSI-RS.

In some implementations, process 300 may further involve processor 210 performing other operations. For instance, process 300 may involve processor 210 configuring a CMR associated with the SRS resource of apparatus 200 based on the NZP CSI-RS. Moreover, process 300 may involve processor 210 measuring a channel response of a communication channel between apparatus 200 (as UE 110) and network node 115 using the CMR. Furthermore, process 300 may involve processor 210 performing an EVD or SVD on the channel response to determine a vector for the UL transmission.

In some implementations, in generating the precoder based on the measured channel response and the measured interference, process 300 may involve processor 210 generating the precoder using the vector and based on the measured interference.

In some implementations, in performing the UL transmission to network node 115 using the precoder, process 400 may involve processor 210 transmitting, via transceiver 230, a SRS to network node 115 using the precoder.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), from a network node of a wireless network a downlink (DL) measurement reference signal;
configuring, by the processor, an interference measurement resource (IMR) associated with a sounding reference signal (SRS) resource of the UE based on the DL measurement reference signal;
measuring, by the processor, a channel response of a communication channel between the UE and the network node;
measuring, by the processor, an interference using the IMR;
generating, by the processor, a precoder based on the measured channel response and the measured interference; and
performing, by the processor, an uplink (UL) transmission to the network node using the precoder.

2. The method of claim 1, wherein the IMR comprises one or more zero-power (ZP) IMRs.

3. The method of claim 1, wherein the IMR comprises one or more non-zero-power (NZP) IMRs.

4. The method of claim 1, wherein the IMR comprises one or more zero-power (ZP) IMRs and one or more non-zero-power (NZP) IMRs.

5. The method of claim 1, wherein the receiving of the DL measurement reference signal comprises receiving a non-zero-power (NZP) channel state information reference signal (CSI-RS).

6. The method of claim 5, further comprising:
configuring, by the processor, a channel measurement resource (CMR) associated with the SRS resource of the UE based on the NZP CSI-RS; and
performing, by the processor, an eigen-value decomposition (EVD) or singular-value decomposition (SVD) on the channel response to determine a vector for the UL transmission.

7. The method of claim 6, wherein the generating of the precoder based on the measured channel response and the measured interference comprises generating the precoder using the vector and based on the measured interference.

8. A method, comprising:
receiving, by a processor of a user equipment (UE), from a first network node of a wireless network a downlink (DL) measurement reference signal;
configuring, by the processor, an interference measurement resource (IMR) associated with a sounding reference signal (SRS) resource of the UE based on the DL measurement reference signal;
measuring, by the processor, an interference using the IMR;
generating, by the processor, a precoder based at least in part on the measured interference; and
performing, by the processor, an uplink (UL) transmission to the first network node using the precoder such that an amount of interference caused by the UL transmission on a second network node of the wireless network is reduced.

9. The method of claim 8, wherein the IMR comprises one or more zero-power (ZP) IMRs.

10. The method of claim 8, wherein the IMR comprises one or more non-zero-power (NZP) IMRs.

11. The method of claim 8, wherein the IMR comprises one or more zero-power (ZP) IMRs and one or more non-zero-power (NZP) IMRs.

12. The method of claim 8, wherein the receiving of the DL measurement reference signal comprises receiving a non-zero-power (NZP) channel state information reference signal (CSI-RS).

13. The method of claim 12, further comprising:
configuring, by the processor, a channel measurement resource (CMR) associated with the SRS resource of the UE based on the NZP CSI-RS;
measuring, by the processor, a channel response of a communication channel between the UE and the first network node using the CMR; and
performing, by the processor, an eigen-value decomposition (EVD) or singular-value decomposition (SVD) on the channel response to determine a vector for the UL transmission.

14. The method of claim 13, wherein the generating of the precoder based on the measured channel response and the measured interference comprises generating the precoder using the vector and based on the measured interference.

15. An apparatus, comprising:
a processor capable of:
receiving from a network node of a wireless network a downlink (DL) measurement reference signal;
configuring a channel measurement resource (CMR) associated with a sounding reference signal (SRS) resource of the apparatus based on the DL measurement reference signal;
configuring an interference measurement resource (IMR) associated with the SRS resource based on the DL measurement reference signal;
measuring a channel response of a communication channel between the UE and the network node using the CMR;
measuring an interference using the IMR;
generating a precoder based on the measured channel response and the measured interference; and
performing an uplink (UL) transmission to the network node using the precoder.

16. The apparatus of claim 15, wherein the IMR comprises one or more zero-power (ZP) IMRs.

17. The apparatus of claim 15, wherein the IMR comprises one or more non-zero-power (NZP) IMRs.

18. The apparatus of claim 15, wherein the IMR comprises one or more zero-power (ZP) IMRs and one or more non-zero-power (NZP) IMRs.

19. The apparatus of claim 15, wherein, in receiving the DL measurement reference signal, the processor is capable of:
receiving a non-zero-power (NZP) channel state information reference signal (CSI-RS),
wherein, in configuring the CMR associated with the SRS resource of the apparatus based on the DL measurement reference signal, the processor is capable of configuring the CMR based on the NZP CSI-RS.

20. The apparatus of claim 19, wherein the processor is further capable of:
performing an eigen-value decomposition (EVD) or singular-value decomposition (SVD) on the channel response to determine a vector for the UL transmission,
wherein, in generating the precoder based on the measured channel response and the measured interference, the processor is capable of generating the precoder using the vector and based on the measured interference.
